(19) United States
(12) Patent Application Publication
(10) Pub. No.: US 2026/0318494 A1
(43) Pub. Date: Oct. 15, 2026

(54) PROJECTION MODULE FOR A MOTOR VEHICLE HEADLAMP

(71) Applicant: ZKW Group GmbH, Wieselburg (AT)

(72) Inventor: Bernd TEMPER, Markersdorf (AT)

(73) Assignee: ZKW Group GmbH, Wieselburg (AT)

(21) Appl. No.: 19/639,764

(22) Filed: Apr. 6, 2026

(30) Foreign Application Priority Data
Apr. 11, 2025 (EP) 25170013.4

(51) Int. Cl. F21S 41/27; F21S 41/141

(52) U.S. Cl. CPC F21S 41/27; F21S 41/141

(57) ABSTRACT

Projection module (10, 20) for a motor vehicle headlamp, wherein the projection module (10) is configured to generate a segmented high beam light distribution and an additional light distribution in front of the projection module (10, 20) in a main direction (X), wherein the projection module (10, 20) comprises:
an optic body (100) with light guide elements (200) having a first light entry surface for first light sources (50),
a projection lens system (300),
   wherein the projection module (10, 20) comprises
an additional light guide component (400) separate from the optic body (100),
   wherein at least two light guide elements (200) having a second light entry surface (230) corresponding to the second light exit surface (420) of the additional light guide component (400), wherein the second light entry surface (230) of the at least two light guide elements (200) are configured to receive light emitted from the second light exit surface (420) of the additional light guide component (400) for coupling the light into the optic body (100), wherein light received from the second light entry surface exiting the optic body (100) via the common light output surface (220a) of the optic body (100),
   and wherein the projection lens system (300) is configured to project the light of the at least one second light source (60) emerging from the common light exit surface (220a) in front of the projection module (10, 20) in the main direction (X) as the additional light distribution

The invention relates to a projection module for a motor vehicle headlamp, wherein the projection module is configured to generate a segmented high beam light distribution and an additional light distribution in front of the projection module in a main direction, wherein the projection module comprises:
an optic body, comprising a base body and a plurality of light guide elements protruding from the base body for forming the segmented high beam distribution from light emitted by first light sources, wherein each light guide element comprises a first light entry surface, into which light from the first light sources can be coupled, and a first light exit surface, from which light that has been coupled into the respective light guide element exits,
   wherein the first light exit surfaces of adjacent light guide elements directly adjoin one another and form a common light exit surface of the optic body, wherein preferably the light guide elements of the optic body are arranged in at least one row along a straight line,
a plurality of first light sources, wherein at least one first light source is assigned to each first light entry surface of a light guide element,
a projection lens system downstream of the optic body along the main direction and comprising at least one projection lens, wherein the projection lens system is configured to project the light of the first light sources emerging from the common light exit surface in front of the projection module in the main direction as the segmented high beam light distribution.

Further, the invention relates to a motor vehicle headlamp comprising at least one projection module according to the invention.

Conventional projection modules for motor vehicle headlamps are typically designed to generate a fixed or adaptive high beam light distribution using a set of light sources and a downstream projection lens system. While such arrangements allow for segmented high beam patterns, they often suffer from limitations in terms of functionality, flexibility, and modularity.

One major drawback of the prior art lies in the lack of integration of secondary lighting functions—such as symbol projection or near-field illumination—within a single compact projection module. In many cases, these functions require additional separate optical units or modules, which increases the overall complexity, space requirements, and cost of the headlamp system. Moreover, integrating separate modules for different light distributions leads to redundant optical components and light sources, reducing overall system efficiency.

Furthermore, existing segmented high beam systems are commonly limited in their ability to dynamically combine different light distributions through a shared optical path. The optical paths for primary and secondary lighting are often physically and functionally separate, making it difficult to synchronize or blend their output effectively. This restricts design flexibility and impairs seamless transitions between different lighting scenarios.

Another disadvantage in the state of the art is the limited controllability and resolution of the light distribution. Many known solutions do not allow individual control over each segment or rely on shared light sources for multiple segments, leading to non-uniform brightness levels and limited configurability. Additionally, the use of separately mounted optical components often results in alignment inaccuracies and increased assembly tolerances, which can degrade the precision of the projected light pattern.

Moreover, known designs often involve complex mechanical interfaces or rigid coupling between light guide components and light sources, making thermal management challenging and limiting the ability to isolate or optimize thermal flows within the module. This can result in thermal cross-talk, reduced LED performance, and long-term reliability concerns.

In summary, the prior art fails to provide a compact, integrative, and optically efficient solution that allows both segmented high beam generation and additional lighting functionality through a shared, modular optical system with high precision and independent control.

It is an object of the invention to provide an enhanced projection module for a motor vehicle headlamp.

To achieve this object the projection module comprises
an additional light guide component separate from the optic body, comprising at least one light input device into which light from at least one second light source can be coupled, and a second light exit surface, from which light that has been coupled into the additional light guide component exits,
at least one second light source,
   wherein at least two light guide elements having a second light entry surface corresponding to the second light exit surface of the additional light guide component, wherein the second light entry surface of the at least two light guide elements are configured to receive light emitted from the second light exit surface of the additional light guide component for coupling the light into the optic body, wherein light received from the second light entry surface exiting the optic body via the common light output surface of the optic body, and wherein the projection lens system is configured to project the light of the at least one second light source emerging from the common light exit surface in front of the projection module in the main direction as the additional light distribution.

The projection module allows the generation of both a segmented high beam light distribution and an additional light distribution, such as a symbol light or near-field illumination, using a modular architecture. The use of a separate additional light guide component enables the implementation of auxiliary lighting functions without interfering with the core high beam functionality. This modularity enhances system flexibility and enables multi-functional lighting solutions within compact headlamp designs.

Advantageously, each light guide element has assigned at least one first light source to their respective first light entry surface.

Assigning at least one dedicated light source to each light guide element ensures uniform brightness and high-resolution segmentation of the high beam. This allows precise control over individual light segments, resulting in a highly customizable and responsive lighting system tailored to dynamic driving scenarios.

Advantageously, the first light sources of each light guide element is independently controllable.

Independent control of the first light sources for each light guide element enables dynamic high beam adaptation, such as glare-free high beam or adaptive headlight functions. This improves both driving safety and user comfort by automatically adjusting the light pattern to avoid dazzling oncoming traffic.

Advantageously, the optic body is integrally formed.

The integrally formed optic body reduces the number of optical interfaces and assembly steps. It enhances mechanical stability and manufacturing efficiency while minimizing optical losses and alignment errors, thereby improving overall light transmission and thermal conductivity.

Advantageously, the additional light distribution is a sign-light light distribution.

By defining the additional light distribution as a symbol light, the projection module supports advanced communication functions between the vehicle and its environment, such as the projection of warning signs or status indicators onto the road. This enhances road safety and paves the way for future autonomous or cooperative driving systems.

Advantageously, the light guide elements extend substantially parallel to the main direction.

Substantially parallel alignment of the light guide elements with the main direction improves optical efficiency by minimizing internal reflections and bending losses. This orientation also allows for a compact module depth, which is beneficial in modern slim headlamp designs.

Advantageously, the at least one light input device of the additional light guide component is built as a TIR-optics or a collimator.

The implementation of the light input device as a TIR (Total Internal Reflection) optic or collimator optimizes the coupling efficiency of light into the additional light guide component. This enhances beam shaping accuracy and supports high luminance output while keeping energy consumption low.

Advantageously, the additional light guide component comprises a first light spreading section which extends from the light input device, wherein the first light spreading section comprises at least one out-coupling section for coupling out at least a part of the light coupled into the additional light guide component via the light input device to the second light exit surface, wherein the additional light guide component comprises a deflection device which is configured to deflect the coupled-in light toward the at least one outcoupling section, wherein the deflection device comprises a first reflection surface that is configured to deflect, by reflection, at least part of the light coupled in by the light input device in a light coupling-in direction into a first deflection direction in the first light spreading section.

The use of a first light spreading section with at least one out-coupling region allows for controlled light distribution from the additional light guide component. The integration of a deflection device with a reflective surface ensures that light is redirected with minimal loss toward the designated coupling-out area, enhancing the homogeneity and precision of the projected additional light.

Advantageously, the additional light guide component comprises a second light spreading section which extends from the light input device in a different direction to the first light spreading section, wherein the second light spreading section comprises at least one out-coupling section for coupling out at least a part of the light coupled into the additional light guide component via the light input device to the second light exit surface, wherein the deflection device comprises a second reflection surface that is configured to deflect, by reflection, at least a part of the light coupled in by the light input device into a second deflection direction in the second light spreading section.

The inclusion of a second light spreading section branching in a different direction allows for multi-directional light output from a single light input source. This design supports complex light patterns or multi-zone illumination, improving the flexibility of the lighting function without requiring additional modules.

Advantageously, the coupling-in direction is different from the deflection direction, wherein preferably the second deflection direction is different from the deflection direction and the coupling-in direction.

By defining distinct light deflection directions relative to the coupling-in direction, the light can be selectively routed within the light guide component. This improves optical control and enables the generation of spatially separated light distributions from a compact and integrated optical structure

Advantageously, the additional light guide component comprises for each light guide element, which has a second light entry surface, one light input device assigned to the respective second light entry surface.

Assigning a dedicated light input device to each light guide element that receives light from the additional light guide component allows for individual addressing of secondary light paths. This supports selective activation of segments in the additional light distribution, increasing the system's functionality and interactivity.

Advantageously, each light input device has at least one second light source assigned to it, wherein preferably the second light sources are independently controllable.

The configuration where each light input device is associated with an independently controllable second light source enables fine-tuned control over the additional light pattern. This facilitates user-specific or situation-specific light outputs, such as dynamic symbol projection or selective environmental illumination.

Advantageously, the additional light guide component is arranged relative to the optic body that between the second light exit surface of the additional light guide component and each second light entry surface is an air gap or is no air gap.

The possibility of having an air gap or direct optical contact between the second light exit surface and the second light entry surface allows flexibility in thermal and mechanical design. It facilitates thermal decoupling or optical precision depending on application needs, enhancing design freedom and integration efficiency.

Advantageously, the second light entry surfaces of the respective light guide elements—seen in in the y-direction of a cartesian coordinate system, in which the main direction is parallel to the x-direction of the cartesian coordinate system—are inclined at an angle with respect to the main direction, which angle is unequal from 90°.

Inclining the second light entry surfaces relative to the main direction enables better alignment with the exiting light rays from the additional light guide component. This reduces coupling losses and improves the directionality and intensity of the projected light.

Advantageously, the second light exit surface is parallel to the second light entry surface.

A parallel alignment of the second light exit surface and the second light entry surface allows for optimal optical coupling, minimizing divergence and reflection losses. This supports efficient light transfer and compact module design.

Advantageously, the second light exit surface is inclined to the second light entry surface and there is an air gap between the additional light guide component and the optical body.

An inclined configuration with an air gap allows tailored optical paths and thermal isolation, offering additional flexibility in managing optical performance and heat dissipation in compact or enclosed headlamp systems.

Advantageously, the first light sources and/or the second light sources are built as at least one LED.

The use of LEDs as first and/or second light sources ensures long lifetime, high luminous efficacy, and compact integration. Their rapid switching behavior also supports real-time control features, such as adaptive lighting or communication signals.

Advantageously, second light entry surface of the at least two light guide elements is on the same side as the first light entry surface; optic body having a light output side and the light input side opposite to the light output side, the first and second light entry surfaces are on the light input side of the optic body

Advantageously, the projection module further comprises a device for generating a low beam light distribution, preferably a segmented low beam light distribution.

For example, for a low beam light distribution (e.g., Class C, Class V, Class E), a certain portion of light is typically required above the horizontal cut-off line in order to ensure sufficient illumination of overhead elements such as traffic signs. This portion of light above the cut-off line is commonly referred to as “sign light” or “Zone III illumination”. It can be used, for example, to improve the visibility of overhead signboards in traffic environments. Relevant measurement points for evaluating this light distribution may include, for instance, S50LL, S50, and S50RR (located along the V4° line), as well as S100LL, S100, and S100RR (located along the V2° line). These definitions and requirements are in particular specified in European ECE regulations, such as UNECE Regulation No. 112 and Regulation No. 123, but similar criteria may also apply under other international standards and regional homologation frameworks.

The object of the invention is also achieved by a motor vehicle headlamp comprising at least one projection module according to the invention.

### SHORT DESCRIPTION OF THE DRAWINGS

In the following, in order to further demonstrate the present invention, illustrative and non-restrictive embodiments are discussed, as shown in the drawings, which show:

FIG. 1 a schematic side view of an exemplary projection module comprising an optic body, an additional light guide component and a projection lens system;

FIG. 2 a schematic side view of a further exemplary projection module, wherein the difference to the projection module of FIG. 1 is no air gap between the additional light guide component and the optic body;

FIG. 3 a perspective back view of the optic body of FIG. 1 and FIG. 2, wherein the optic body comprises a plurality of light guide elements each of which having a first light entry surface for first light sources, wherein some light guide elements having a second light entry surface for light emitted by the additional light guide component;

FIG. 4 a schematic top view of an embodiment of the additional light guide component, wherein the additional light guide component having a first and second light spreading section extending from the light input device;

FIG. 5 a schematic top view of the optic body and the additional light guide component of FIG. 4;

FIG. 6 a schematic top view of a further embodiment of the projection module, wherein the difference to the embodiment before is a further embodiment of the additional light guide component having a light input device for each light guide element having a second light entry surface;

FIG. 7 a schematic additional light distribution projected from the projection module; and

FIG. 8 a schematic segmented high beam light distribution projected from the projection module.

FIG. 1 shows an exemplary projection module 10 for a motor vehicle headlamp in a schematic side view, wherein the projection module 10 is configured to generate a segmented high beam light distribution and an additional light distribution in front of the projection module 10 in a main direction X, wherein the projection module 10 comprises an optic body 100, comprising a base body 110 and a plurality of light guide elements 200 protruding from the base body 110 for forming the segmented high beam distribution from light emitted by first light sources 50. The optic body 100 is integrally formed. Further, the light guide elements 200 extend substantially parallel to the main direction X.

Each light guide element 200 comprises a first light entry surface 210, into which light from the first light sources 50 can be coupled, and a first light exit surface 220, from which light that has been coupled into the respective light guide element 200 exits.

The first light exit surfaces 220 of adjacent light guide elements 200 directly adjoin one another and form a common light exit surface 220a of the optic body 100, wherein the light guide elements 200 of the optic body 100 are arranged in at least one row along a straight line SL—in the shown embodiment of FIG. 1, there the light guide elements 200 are arranged in one row.

Further, the projection module 10 comprises a plurality of first light sources 50, wherein at least one first light source 50 is assigned to each first light entry surface 210 of a light guide element 200. Each light guide element 200 has assigned at least one first light source 50 to their respective first light entry surface 210. Also, the first light sources 50 are independently controllable in order to blend out segments in the segmented high beam distribution if needed.

Further, the projection module 10 comprises a projection lens system 300 downstream of the optic body 100 along the main direction X and comprising in the shown embodiment one projection lens 310. The projection lens system 200 is configured to project the light of the first light sources 50 emerging from the common light exit surface 220a in front of the projection module 10 in the main direction X as the segmented high beam light distribution.

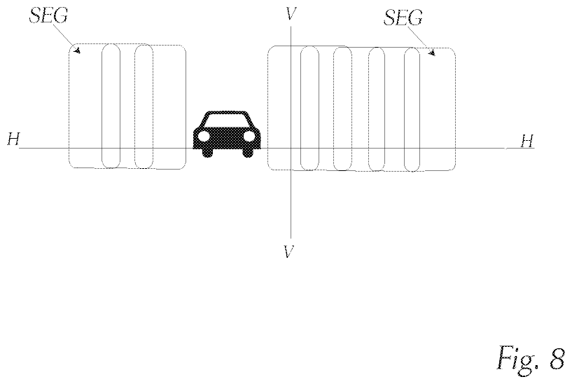

An example of such a segmented high beam light distribution which is formed of several segments SEG which can be independently turned on and off, is shown in FIG. 8. As can also be seen, adjacent segments SEG overlap each other to some degree.

The projection module 10 further comprises second light sources 60 and an additional light guide component 400 separate from the optic body 100, comprising at least one light input device 410 into which light from at least one second light source 60 can be coupled, and a second light exit surface 420, from which light that has been coupled into the additional light guide component 400 exits.

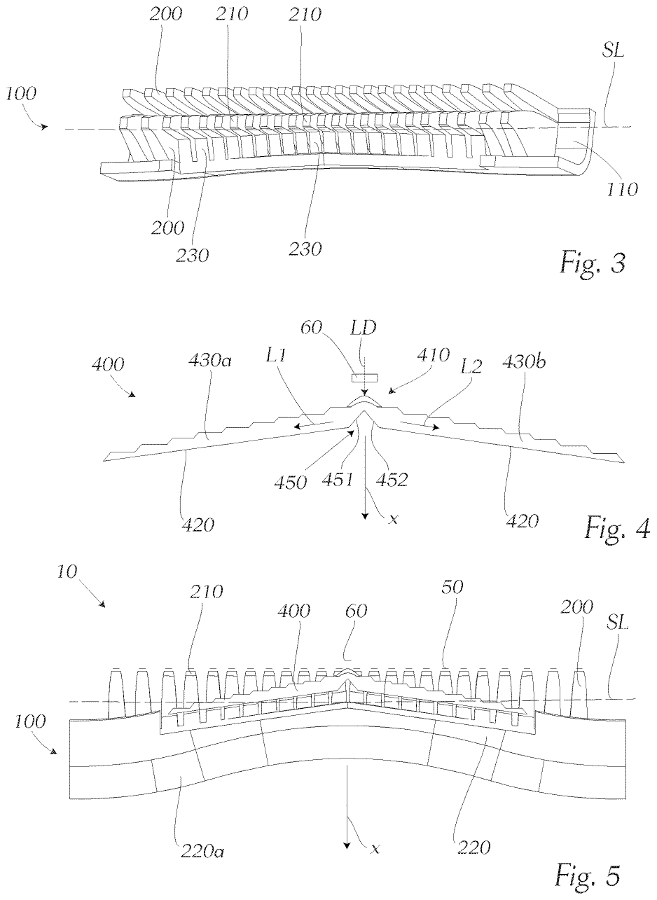

In the shown embodiments, several light guide elements 200 having a second light entry surface 230 corresponding to the second light exit surface 420 of the additional light guide component 400, which can also be seen for example in FIG. 3.

The second light entry surface 230 of the at least two light guide elements 200 are configured to receive light emitted from the second light exit surface 420 of the additional light guide component 400 for coupling the light into the optic body 100, wherein light received from the second light entry surface exiting the optic body 100 via the common light output surface 220a of the optic body 100.

The projection lens system 300 is configured to project the light of the second light sources 60 emerging from the common light exit surface 220a in front of the projection module 10 in the main direction X as the additional light distribution.

As can be seen in the shown embodiments, the second light entry surfaces 230 of the respective light guide elements 200 is on the same side as the first light entry surface. The optic body 100 having a light output side and the light input side opposite to the light output side, the first and second light entry surfaces 210, 230 are on the light input side of the optic body 100.

The additional light distribution is in the shown examples a sign-light light distribution, which can also be referred to as ZoneIII distribution according to ECE guidelines. An example of such an a sign-light light distribution is shown in FIG. 7.

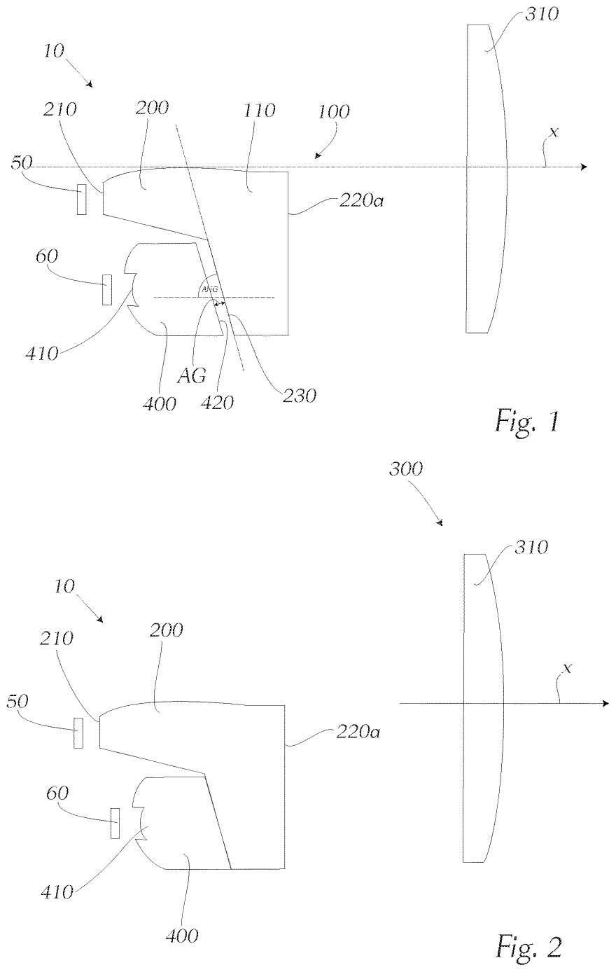

In the embodiment of FIG. 1, FIG. 2, FIG. 4 and FIG. 5, the additional light guide component 400 comprises one light input device 410, which is built as a TIR-optics or a collimator.

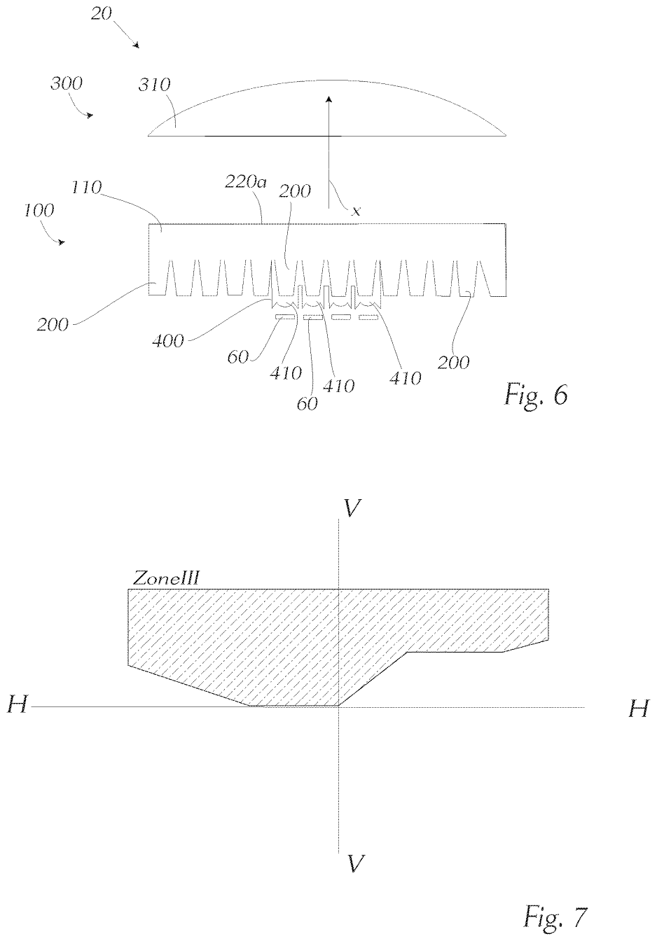

FIG. 6 shows a further embodiment of a projection module 20 which only differs to embodiments described before insofar as the additional light guide component 400 comprises several light input devices 410. In particular, the additional light guide component 400 comprises for each light guide element 200, which has a second light entry surface 230, one light input device 410 assigned to the respective second light entry surface 230. Also in this embodiment, the light input devices 410 are built as TIR-optics or a collimators. Further, each light input device 410 has at least one second light source 60 assigned to it, wherein the second light sources 60 are independently controllable. Thus, the additional light distribution is segmented, wherein each segment can independently turned off and on.

Referring to FIG. 4, this figure shows an embodiment of the additional light guide component 400 which can also used in the projection module 10 shown in FIG. 1 and FIG. 2. The shown additional light guide component 400 comprises a first light spreading section 430a which extends from the light input device 410. The first light spreading section 430a comprises an out-coupling section for coupling out at least a part of the light coupled into the additional light guide component 400 via the light input device 410 to the second light exit surface 420.

Further, the additional light guide component 400 in FIG. 4 comprises a second light spreading section 430b which extends from the light input device 410 in a different direction to the first light spreading section 430a. The second light spreading section 430b comprises an out-coupling section for coupling out at least a part of the light coupled into the additional light guide component 400 via the light input device 410 to the second light exit surface 420.

The additional light guide component 400 further comprises a deflection device 450 which is configured to deflect the coupled-in light toward the outcoupling section of the first and second light spreading section 430a, 430b. The deflection device 450 comprises a first reflection surface 451 that is configured to deflect, by reflection, at least part of the light coupled in by the light input device 410 in a light coupling-in direction LD into a first deflection direction L1 in the first light spreading section 430a.

Further, the deflection device 450 comprises a second reflection surface 452 that is configured to deflect, by reflection, at least a part of the light coupled in by the light input device 410 into a second deflection direction L2 in the second light spreading section 430b.

The coupling-in direction LD is different from the deflection direction L1, wherein the second deflection direction L2 is different from the deflection direction L1 and the coupling-in direction LD.

Further, the additional light guide component 400 is arranged relative to the optic body 100 that between the second light exit surface 420 of the additional light guide component 400 and each second light entry surface 230 is an air gap AG, as can be seen in FIG. 1, or is no air gap AG, as can be seen in FIG. 2.

Also to be seen in FIG. 1 and FIG. 2, the second light entry surfaces 230 of the respective light guide elements 200—seen in in the y-direction of a cartesian coordinate system, in which the main direction X is parallel to the x-direction of the cartesian coordinate system—are inclined at an angle ANG with respect to the main direction X, which angle ANG is unequal from 90°. Further, the second light exit surface 420 is parallel to the second light entry surface 230, as can also be seen in FIG. 5.

It should be mentioned that the additional light guide component 400 in FIG. 1 and FIG. 2 can be the embodiment shown in FIG. 4 and FIG. 6.

It should also be mentioned that the first light sources 50 and the second light sources 60 are built as at least one LED in each shown embodiment.

Also, the projection module 10, 20 may also comprises a device for generating a low beam light distribution, preferably a segmented low beam light distribution, which, however, is not shown in the figures.

### LIST OF REFERENCE SYMBOLS

Projection module . . . 10, 20
First light sources . . . 50
Second light sources . . . 60
Optic body . . . 100
Base body . . . 110
Light guide element . . . 200
First light entry surface . . . 210
First light exit surface . . . 220
Common light exit surface . . . 220a
Second light entry surface . . . 230
Projection lens system . . . 300
Projection lens . . . 310
Additional light guide component . . . 400
Light input device . . . 410
Second light exit surface . . . 420
First light spreading section . . . 430a
Second light spreading section . . . 430b
Deflection device . . . 450
First reflection surface . . . 451
Second reflection surface . . . 452
Air gap . . . AG
Angle . . . ANG
Light coupling-in direction . . . LD
First deflection direction . . . L1
Second deflection direction . . . L2
Straight line . . . SL
Main direction . . . X

1. Projection module (10, 20) for a motor vehicle headlamp, wherein the projection module (10) is configured to generate a segmented high beam light distribution and an additional light distribution in front of the projection module (10, 20) in a main direction (X), wherein the projection module (10, 20) comprises:
an optic body (100), comprising a base body (110) and a plurality of light guide elements (200) protruding from the base body (110) for forming the segmented high beam distribution from light emitted by first light sources (50), wherein each light guide element (200) comprises a first light entry surface (210), into which light from the first light sources (50) can be coupled, and a first light exit surface (220), from which light that has been coupled into the respective light guide element (200) exits,
wherein the first light exit surfaces (220) of adjacent light guide elements (200) directly adjoin one another and form a common light exit surface (220a) of the optic body (100), wherein preferably the light guide elements (200) of the optic body (100) are arranged in at least one row along a straight line (SL),
a plurality of first light sources (50), wherein at least one first light source (50) is assigned to each first light entry surface (210) of a light guide element (200),
a projection lens system (300) downstream of the optic body (100) along the main direction (X) and comprising at least one projection lens (310), wherein the projection lens system (200) is configured to project the light of the first light sources (50) emerging from the common light exit surface (220a) in front of the projection module (10) in the main direction (X) as the segmented high beam light distribution,
characterized in that
the projection module (10, 20) comprises
an additional light guide component (400) separate from the optic body (100), comprising at least one light input device (410) into which light from at least one second light source (60) can be coupled, and a second light exit surface (420), from which light that has been coupled into the additional light guide component (400) exits,
at least one second light source (60),
wherein at least two light guide elements (200) having a second light entry surface (230) corresponding to the second light exit surface (420) of the additional light guide component (400), wherein the second light entry surface (230) of the at least two light guide elements (200) are configured to receive light emitted from the second light exit surface (420) of the additional light guide component (400) for coupling the light into the optic body (100), wherein light received from the second light entry surface exiting the optic body (100) via the common light output surface (220a) of the optic body (100),
and wherein the projection lens system (300) is configured to project the light of the at least one second light source (60) emerging from the common light exit surface (220a) in front of the projection module (10, 20) in the main direction (X) as the additional light distribution.

2. Projection module according to claim 1, wherein each light guide element (200) has assigned at least one first light source (50) to their respective first light entry surface (210).

3. Projection module according to claim 1, wherein the first light sources (50) of each light guide element (200) is independently controllable.

4. Projection module according to claim 1, wherein the optic body (100) is integrally formed.

5. Projection module according to claim 1, wherein the additional light distribution is a sign-light light distribution.

6. Projection module according to claim 1, wherein the at least one light input device (410) of the additional light guide component (400) is built as a TIR-optics or a collimator.

7. Projection module according to claim 1, wherein the additional light guide component (400) comprises a first light spreading section (430a) which extends from the light input device (410), wherein the first light spreading section (430a) comprises at least one out-coupling section for coupling out at least a part of the light coupled into the additional light guide component (400) via the light input device (410) to the second light exit surface (420),
wherein the additional light guide component (400) comprises a deflection device (450) which is configured to deflect the coupled-in light toward the at least one outcoupling section, wherein the deflection device (450) comprises a first reflection surface (451) that is configured to deflect, by reflection, at least part of the light coupled in by the light input device (410) in a light coupling-in direction (LD) into a first deflection direction (L1) in the first light spreading section (430a).

8. Projection module according to claim 7, wherein the additional light guide component (400) comprises a second light spreading section (430b) which extends from the light input device (410) in a different direction to the first light spreading section (430a), wherein the second light spreading section (430b) comprises at least one out-coupling section for coupling out at least a part of the light coupled into the additional light guide component (400) via the light input device (410) to the second light exit surface (420),
wherein the deflection device (450) comprises a second reflection surface (452) that is configured to deflect, by reflection, at least a part of the light coupled in by the light input device (410) into a second deflection direction (L2) in the second light spreading section (430b),
wherein preferably the coupling-in direction (LD) is different from the deflection direction (L1), wherein preferably the second deflection direction (L2) is different from the deflection direction (L1) and the coupling-in direction (LD).

9. Projection module according to claim 1, wherein the additional light guide component (400) comprises for each light guide element (200), which has a second light entry surface (230), one light input device (410) assigned to the respective second light entry surface (230), wherein preferably each light input device (410) has at least one second light source (60) assigned to it, wherein preferably the second light sources (60) are independently controllable.

10. Projection module according to claim 1, wherein the additional light guide component (400) is arranged relative to the optic body (100) that between the second light exit surface (420) of the additional light guide component (400) and each second light entry surface (230) is
an air gap (AG)
or
is no air gap (AG).

11. Projection module according to claim 1, wherein the second light entry surfaces (230) of the respective light guide elements (200)—seen in in the y-direction of a cartesian coordinate system, in which the main direction (X) is parallel to the x-direction of the cartesian coordinate system—are inclined at an angle (ANG) with respect to the main direction (X), which angle (ANG) is unequal from 90°.

12. Projection module according to claim 1, wherein the second light exit surface (420) is parallel to the second light entry surface (230).

13. Projection module according to claim 1, wherein the second light exit surface (420) is inclined to the second light entry surface (230) and there is an air gap between the additional light guide component (400) and the optical body (100).

14. Projection module according to claim 1, wherein the first light sources (50) and/or the second light sources (60) are built as at least one LED.

15. Motor vehicle headlamp comprising at least one projection module according to claim 1.
